(19) United States
(12) Patent Application Publication
(10) Pub. No.: US 2019/0136165 A1
(43) Pub. Date: May 9, 2019

(54) METHODS FOR PRODUCING COLOR-CONCENTRATED WINE PRODUCTS

(71) Applicant: American Winesecrets, LLC, Sebastopol, CA (US)

(72) Inventor: Eric T. Dahlberg, Napa, CA (US)

(73) Assignee: American Winesecrets, LLC, Sebastopol, CA (US)

(21) Appl. No.: 16/182,493

(22) Filed: Nov. 6, 2018

Related U.S. Application Data
(60) Provisional application No. 62/582,218, filed on Nov. 6, 2017.

(51) Int. Cl. C12G 1/02; C12G 3/08; C12H 1/16; B01D 61/14

(52) U.S. Cl. CPC C12G 1/02; B01D 61/145; C12H 1/16; C12G 3/085

(57) ABSTRACT

Provided are methods for generating color-concentrated wine products, where the concentrated wine products are manufactured by combining flash détente processing, fermentation and tangential flow filtration. The concentrated wine products can be used for making blended wines, or as a finished drinking wine, or as a highly concentrated additive that can be used for enhancing other wines or used in food preparation.

### CROSS-REFERENCE TO RELATED APPLICATIONS

This application claims benefit of U.S. Provisional Application Ser. No. 62/582,218, filed November 6, 2017, which is herein incorporated by reference in its entirety.

### FIELD OF THE INVENTION

The invention relates to methods and compositions for the manufacture of enhanced wine products for human consumption. The invention finds particular use, but not exclusively, for the generation of enhanced wines that have improved color properties. The invention relates to methods for producing concentrated wine products that find use in producing blended wines that have improved properties.

### BACKGROUND OF THE INVENTION

Overt as well as subtle organoleptic properties of wines are critical for wine appeal and distinguishing one wine from another. Vintners recognize the value of closely monitoring and controlling these properties. For example, the concentration of color pigments is often critical for wine appeal, where deeper and darker colors are often viewed as more appealing compared to other wines that do not have such color intensity. Other organoleptic properties such as mouth feel also contribute to wine appeal.

Wine is a natural product, and thus, is subject to color variation. Color varies greatly with wine processing practices, particularly fermentation techniques. Wine coloration can vary from lot-to-lot, vintage-to-vintage, over the course of a single season, in the crafting of varietal blends and in the aging of a wine over an extended time. Vintners often have a challenge in regulating the color intensity of wines also because of the constraints of traditional wine manufacturing methods. Maintaining color consistency can be an important factor for many wineries, and wineries must consider what is acceptable color variation.

Wine color plays a significant role in the perception of quality and is also a useful metric in wine development. Quantitative color analysis allows winemakers to precisely monitor and record wine colors for research, product consistency, quality control and in the crafting of new wines. Color analysis allows wineries to document the effects of fermentation, as well as other variables, on wine color. Once a control or reference value has been established, future analysis can compare the results of one fermentation program to another.

The color intensity of a wine relates to wine appearance, specifically, the concentration of color. The more concentrated and opaque a wine's color, the higher its color intensity. Common descriptors for color intensity include pale, medium and dark. Beyond these subjective descriptions, more analytical metrics are also used in the industry to describe color intensity.

Winemakers traditionally rely on a narrow spectrum of UV-visible spectrophotometry wavelengths to quantify wine color and to quantitate color nuance. The amount of light that wine absorbs at two key wavelengths, namely 420 nm and 520 nm, is commonly used in the industry to measure wine color. Absorption at 620 nm is also measured in some applications. Winemakers can develop an impression of a wine's color properties by considering these absorption values, as well as the sums and ratios of these values in describing a wine's total color and hue. It is noted that the absorption spectra of two different wines can be very similar in profile, but the intensity of the absorption at the measured wavelengths can vary considerably.

What is needed in the art are improved methods for wine production, and specifically, methods for wine production that result in wines having improved character in color intensity, such as in red wines, and/or other improved organoleptic properties. What is needed in the art are methods for wine production where various organoleptic properties of a wine, such as color intensity of a red wine, can be fine tuned to produce a wine with preferred or standardized characteristics. What is needed in the art are materials and methods that give the vintner the ability to regulate the key organoleptic characteristics of any given wine. Furthermore, what is needed are improved methods for wine production that give the vintner the ability to reproducibly manufacture new wine varieties. What is needed in the art are methods that give the vintner to ability to adjust the organoleptic properties of a lesser-quality wine, such as the color intensity of a red wine, in order to improve the color intensity of that lesser quality wine.

The present invention, in its many embodiments, provides methods that overcome these challenges in the art, have advantages over the state of the art and provide many benefits previously unrealized in methods currently used in the art. Still further benefits flow from the invention described herein, as will be apparent upon reading the present disclosure.

### SUMMARY OF THE INVENTION

Most generally, the invention provides methods for generating concentrated wine products, more specifically, wine products that are color-concentrated, the method comprising:

(i) generating a grape must from a Vitis vinifera grape varietal or similar cultivar;

(ii) subjecting the grape must to flash détente processing, which includes a heat treatment, for example to 180° F., followed by exposure to vacuum, with values for example between 7 and 10 inches of mercury (Hg);

(iii) fermenting the processed grape material to generate a crude fermented product;

(iv) subjecting the crude fermented product to tangential flow filtration and collecting a color-concentrated retentate fraction produced by the tangential flow filtration, thereby generating a color-concentrated wine product. Tangential flow ultrafiltration techniques find particular use with the invention.

Pressing of the grape must to produce a clear grape juice can occur either immediately before or immediately after the fermentation step. The fermentation used to produce these products includes both a primarily and a secondary fermentation.

Standard wine finishing steps can be employed with this protocol, for example, secondary fermentation, tartrate and protein stabilization, rough filtration and sterile filtration prior to the color concentration step.

The concentrated wine products of the invention can be of any preferred degree of concentration, which can be expressed by volume reduction of the concentrated product compared to the volume of the starting material. For example, in some embodiments, the concentrated wine product is not more than about 10% of the volume of the crude wine product starting material (i.e., a 90% volume reduction). Alternatively, the concentrated wine product is not more than about 20%, 30%, 50% or 80% of the volume of the crude wine product starting material.

Products thus formed are also a feature of the invention. For example, a concentrated wine product produced by the method of the invention is also a feature of the invention. The concentrated wine product can be described by the degree of concentration, but also by other features, for example, by the color intensity value (the sum of Abs₄₂₀ and Abs₅₂₀) or by the concentrations of any particular color pigments, most significantly anthocyanin pigments.

The invention also provides methods for producing blended wine products, where those methods utilize the concentrated wine products that are a feature of the invention. For example, a method for producing a blended wine is described, where the method utilizes at least one base wine and a concentrated wine additive. The wine additive can be described as having a color density of greater than 3.526, and also having a concentration of total anthocyanins of at least about 1182 mg/L. The two components can be blended in any preferred ratio that yields desirable organoleptic properties, for example, where the volume of the concentrated wine additive is at least 2%, or at least 5% of the volume of the at least one base wine.

### BRIEF DESCRIPTION OF THE DRAWINGS

Aspects, features and advantages of the invention, as to its operation and use, will be understood and more readily apparent when the description of the invention is considered in light of the following drawings.

FIG. 1 provides a flowchart describing one embodiment of the methods of the invention, where the flowchart shows generally the steps for the production of a color-concentrated wine product of the invention.

FIG. 2 provides a schematic illustration showing one embodiment of the invention, where the illustration depicts a flash détente processing step finding use with the methods of the invention in the production of a concentrated wine product that is used in the production of an enhanced wine product.

FIG. 3 provides a schematic showing one embodiment of the invention, where the schematic shows generally an ultrafiltration processing step finding use with the methods of the invention in the production of a color-concentrated wine product that is used to produce an enhanced wine.

FIGS. 4A and 4B provide full absorbance spectra for two samples. FIG. 4A provides the absorbance spectra of a 2016 California Cabernet red wine. FIG. 4B provides the absorbance spectra of a concentrated wine product, termed UX-520, which was produced by concentrating a 2017 California Cabernet wine using flash detente processing and tangential flow ultrafiltration, as described herein.

FIG. 5A provides a radar plot comparing the analyte content of two different samples. The first sample, termed an average, is a reference value that is an average of analyte content of more than 350 Bordeaux style wines, where the average is heavily weighted to wines less than one year old. The second sample shown in the radar plot is a concentrated wine product of the invention, termed UX-520, which was manufactured using the methods described herein. FIG. 5B shows the analyte concentrations in the UX-520 concentrated wine product. FIG. 5C shows the analyte concentrations in a control wine which is a 2016 California Cabernet red wine.

FIG. 6 provides a complete analyte concentration profile in the UX-520 color-concentrated wine product of the invention, including microbiological testing results.

### DESCRIPTION OF THE INVENTION

In its broadest aspect, the present invention in its various embodiments provides methods for producing a color-concentrated wine product derived from red wine grapes, where the concentrated wine product has an increased concentrations of at least one color pigment and/or at least one other wine component compared to a corresponding non-concentrated wine product from which the color-concentrated product is derived. Methods of the invention generate concentrated wine products that have a variety of uses, most notably as an additive that can be used to enhance or optimize other wines, or a blending component in the production of blended wine products that have an improved organoleptic experience, for example, by increasing color intensity or by facilitating the regulation of color consistencies from batch to batch. The concentrated wine product of the invention can have still other uses when used as an additive or for wine blending, for example, to improve the flavor expression, mouthfeel/viscosity, and color stability properties of a preexisting starting wine.

The color-concentrated wine product of the invention can generally be used as an additive to a preexisting wine, where the volume of concentrated wine product of the invention that is added to the preexisting wine is a relatively small proportion compared to the volume of the starting wine. That is to say, the ratio of the concentrated wine product to the starting wine is relatively small.

Alternatively, the concentrated wine product of the invention can be used as a blending component with a preexisting wine (or combination of wines), where the concentrated wine product of the invention is combined with the preexisting wine in a relatively large proportion, that is to say, there the ratio of the volume of concentrated wine product of the invention to the volume of the preexisting wine used in the combination is relatively large.

Alternatively still, the color-concentrated wine product produced by the methods of the invention can be a stand-alone consumable wine product by itself without combination with any other components. In those embodiments, the wine product can be concentrated, for example, by 5-20%, that is to say, the starting wine material can be reduced in volume by 5-20% by the tangential flow filtration to achieve a color-concentrated product intended for use as a stand-alone drinking product.

Based on the intended use of the concentrated wine product of the invention, the product can be concentrated to a greater or lesser degree. For example, when the concentrated wine product is to be used as an additive in a small ratio to a preexisting wine, the concentrated wine product can be highly concentrated, for example, in excess of 60% concentrated by volume compared to the starting volume of the wine that is concentrated. When the concentrated wine product is to be used as a component in the manufacture of a blended wine, the concentrated wine product can be concentrated, for example, to 30-60% of the starting volume. In other embodiments, for example, where the concentrated wine product is intended to be a stand-alone consumable product without further treatment, the concentrated product can be concentrated to a lesser degree compared to other products that are to be used as an additive, minor component or for making blended wines, for example, can be concentrated to 10-30% of the starting volume.

Most generally, the methods of the invention for the manufacture of concentrated wine products combine techniques to optimize color extraction of the processed grapes with techniques for concentrating the resulting wines (i.e., reducing the wine in aqueous volume but retaining the wine solutes). Essentially, methods of the invention combine flash-détente grape processing, fermentation and tangential flow filtration processing to produce the concentrated wine products of the invention. The resultant wine products manufactured by the methods of the invention are concentrated to a degree that is optimized for the intended use. The invention couples the optimization of color extraction via flash détente with the concentration of that color (as well as other higher molecular weight constituents) in the retentate produced by the subsequent tangential flow filtration.

The invention includes various embodiments, including methods for manufacturing the concentrated wine products, the wine products that are generated by the novel methods, as well as methods for making optimized or blended wine products.

The methods and resulting products described herein find a variety of uses and benefits. The present invention in its various embodiments provides methods for producing concentrated wine products from red wine grapes to create a concentrated wine product having greater concentrations of color pigments and/or macronutrients such as proteins and polysacharrides. The concentrated products thus produced, for example when concentrated 40-70%, can optionally be used for blending with other red wines to enhance the color properties of those other wines and/or for enhancing other organoleptic properties of the starting wine materials. These methods of the invention are commercially desirable as these methods enable wine producers to add desired color or manipulate other properties of red wines without the risk of impacting required volumes of specific varietals or geographical regions, deemed to be important for the resultant modified or blended wine's marketability.

The concentrated red wine product manufactured using the methods of the invention can be sold specifically for blending with other red wines in order to enhance organoleptic properties in the resulting blend, for example, by enhancing the color intensity of the resulting blend. Alternatively, the concentrated wine product manufactured using the methods of the invention can be a highly concentrated product, for example concentrated 70-90% compared to the staring volume, where the highly concentrated product can be used as an additive to a base wine, for example, a varietal red base wine where amelioration of varietal/appellation is of concern. In these embodiments, the addition of a relatively small volume of the highly concentrated additive to the base wine results in improved organoleptic properties of the resulting combination of the treated wine containing the base wine and the additive. In still other embodiments, the methods of the invention result in the concentration of both tannins and color molecules in the filtration retentate, for example, will have higher concentrations of tannin, anthocyanin other and polymeric pigment. This concentrate can be added to other red wines that lack adequate tannin and/or insufficient color intensity.

The resultant color-concentrated material manufactured using the methods of the invention are concentrated to a degree specifically for maximal practical volume reduction. By way of non-limiting example, in some embodiments, a reduction in volume by 80-95% is optimally achieved, that is to say, the resulting concentrated product has a volume that is 5-20% of the starting volume of the fermented product that was used to make the concentrate. The methods of the invention can be used in the manufacture of a specialized component (e.g., to be used as an additive) that can be used in the manufacture of other finished wine products or food products.

The resultant wine products manufactured by the methods of the invention are concentrated (i.e., reduced in volume) to a degree that is optimized for the intended use. For example, some concentrated wine products that are used as stand-alone consumable wines are concentrated to a lesser degree compared to other products that are to be used as an additive or minor component added to a base wine to improve the organoleptic properties of that base wine to generate a finished wine product.

The methods of the invention combine processes for flash détente to enhance color extraction combined with methods for concentration of the wine product by tangential flow filtration, so as to produce a resultant product with elevated concentration of flavonoid compounds (such as anthocyanins and pigmented tannin) compared to what would be found in a wine manufactured by traditional methods, thereby creating a wine product with more intense color and mouthfeel.

### I. Definitions

As used herein, the term “wine” refers broadly to the alcoholic beverage produced by the traditional fermentation of a grape juice, whereby the sugars in the grape juice are metabolized by fermenting yeast resulting in the generation of ethanol. The grapes that are used to produce wines are traditionally a Vitis vinifera varietal or cultivar, or combinations of such varietals and/or cultivars. The production of red wines involves extraction of color and flavor components from the skins of darker-colored grape varieties. The color of the wines that are classified as red wines typically come from phenolic anthocyanin (also termed anthocyan) pigments located primarily in the grape skins.

As used herein, the term “wine product” refers to a liquid product, which may or may not be a drinkable beverage, derived from a wine, where the wine or wine-making process has been manipulated in some manner inconsistent with traditional wine-making methods. For example, a wine that contains additives or is a blend of two or more base wines is a wine product.

As used herein, the expression “concentrated wine product” refers to a wine product that is concentrated in comparison to the traditional wine starting material from which it is derived. The term “concentrated” can mean reduced in volume due to loss of water (i.e., reduced aqueous content), but retaining some subset or all of the wine solutes contained in the original starting material. Wine contains a large, complex mixture of solute materials. These include ethanol, glycerol, organic acids, phenolics including tannins and anthocyanins, proteins, carbohydrates including various sugars, minerals and ions. In other aspects, “concentrated” describes a wine product that has been enriched in at least one molecular component, for example, an anthocyanin pigment that is present in the original fermented wine starting material. As described herein, the color-concentrated wine products of the invention are generated in some embodiments by the use of tangential flow ultrafiltration, and thus, the color-concentrated wine products are fractional concentrated products, where the larger solutes in the starting material are concentrated in the filtration retentate, while the smaller ones are not concentrated. Thus, as generally used herein, the term “concentrated” wine product refers to a color-concentrated wine product which is a fractional concentrated wine product. In other embodiments, a concentrated wine product can be enriched in one or more chemical components.

In some embodiments, a color-concentrated wine product manufactured by any of the methods of the invention is a wine product where the color intensity value, e.g., Abs₄₂₀+Abs₅₂₀, of that wine product is greater than the color intensity value of the original starting fermented material from which the concentrated product was derived.

In other embodiments, a color-concentrated wine product manufactured by any of the methods of the invention is a wine product where the color intensity value, e.g., Abs₄₂₀+Abs₅₂₀, of that wine product is at least 2-fold, or at least 3-fold, or at least 5-fold, or at least 10-fold greater than the color intensity value of the original starting fermented material from which the concentrated product was derived.

In some embodiments, a color-concentrated wine product of the invention is a wine product that has a wine color intensity value, Abs₄₂₀+Abs₅₂₀, of at least 3.526.

A wine can be concentrated to produce a color-concentrated wine product using a tangential flow filtration system, for example, by using a tangential flow ultrafiltration system, where the ultrafiltration retentate is the concentrated wine product. The degree to which the wine starting material is concentrated to produce the concentrated wine product is not particularly limiting, although the degree of concentration can be optimized based on intended use. For example, in some embodiments, a color-concentrated wine product that has been reduced in volume by at least 50% compared to the starting volume of the fermented wine starting material is advantageous in some applications.

As used herein, the expression “blended wine product” refers to a drinking wine that is a blend of at least two or more distinct grape varietals. Blending is used to maximize the expression of a wine, where the blended product can enhance aromas, color, texture, body and finish, making it a more well-rounded and complex wine as a result of the blending. For example, if a wine does not have a strong scent, a winemaker can combine that wine with a wine derived from a more potent smelling grape varietal to improve the quality of the starting material. In the U.S., a single varietal wine needs to be at least 75 percent of one type of grape in order for that wine to call itself a “single varietal” wine. In contrast, blended wines more typically consist of at least 40-50 percent of one predominant type of grape that is then combined with a mixture of two or more other wine varietals.

As used herein, the term “additive” refers to something that is added, as one substance (i.e., the additive) is added to another (i.e., the starting product or base product) in order to alter or improve the quality of the base product, or to counteract a shortcoming or an undesirable property of the base product. The relative volume of the additive that is used is generally significantly smaller than the volume of the base product to which it is added. A concentrated wine product of the invention can act as an additive when the concentrated wine product is added to a base wine or starting wine in order to improve one or more organoleptic property of that base wine, for example, to improve or favorably adjust the color of the resulting modified wine. When a wine product of the invention is used as a wine additive, the degree of concentration of that product is preferably very high in order to minimize the volume of additive that needs to be added to the base wine that is being modified.

As used herein, in one embodiment, the expression “wine color intensity,” or alternatively “color density” or “color concentration” is a measure of how dark the wine is using a summation of absorbance measurements in the violet and green areas of the visible spectrum. Namely, wine color intensity is Abs₄₂₀+Abs₅₂₀ (where Aλ represents the absorbance at given wavelength λ expressed in nanometers, nm). In other embodiments, the expression “wine color intensity” is a measure of how dark the wine is using a summation of absorbance measurements in the violet, green and red areas of the visible spectrum, namely A₄₂₀ nm+A₅₂₀ nm+A₆₂₀ nm. Red wine color intensity is traditionally the summation Abs₄₂₀ and Abs₅₂₀.

As used herein, the expression “wine hue,” sometimes referred to as “wine color tone,” refers to a measure of the appearance of a wine color that is derived as the ratio of the absorbance value in the violet wavelength to the absorbance in the green wavelength, where wine color hue is the ratio Abs₄₂₀Abs₅₂₀.

As used herein, the expression “organoleptic properties” are the sensory characteristics of a food or drink product which encompass taste/flavor, odor, color and texture. Scoring organoleptic properties can involve quantitative assessment and/or qualitative findings. As used herein, the organoleptic properties of wine are those characteristics of wine that are commonly recognized in the wine industry.

As used herein, the expression “organoleptically acceptable” refers to the properties of a food or drink product that makes that food or drink product suitable for consumption. That is to say, an organoleptically acceptable product is a product that does not have off-odors, unpleasant taste/flavor, insufficient or unappealing (e.g., unnatural) color or color intensity or displeasing texture (e.g., gritty, mushy or chewy).

As used herein, the expression “organoleptically desirable” or “organoleptically favorable” or similar expressions refer to the organoleptic properties of a food or drink product that make that food or drink product objectively or subjectively appealing.

As used herein, the expression “enhanced organoleptic properties” or “improved organoleptic properties” are the organoleptic properties of a food or drink product that have been changed by some process or manipulation for the purpose of making the collective organoleptic properties of a product more desirable or improved in comparison to a reference product or starting material. A reference product or starting material can be a food or drink product of the same general category as the enhanced product or can be unprocessed starting material that is used to manufacture the enhanced product.

As used herein, tangential flow filtration, also termed crossflow filtration, is a type of filtration operation different from dead-end batch filtration. In batch filtration, the feed is passed through a membrane, filter or bed, the solids being trapped on or in the filter, and the filtrate is released on the opposite side of the filter. In contrast, in tangential-flow filtration, the majority of the starting material feed flow travels tangentially across the surface of the filter, rather than into the filter, and the feed (and retentate flow) is maintained at a positive pressure relative to the permeate side of the filter membrane. In tangential flow filtration, a proportion of the material which is smaller than the membrane pore size passes through the membrane as permeate (or filtrate); everything else is retained on the feed side of the membrane as retentate.

The principal advantage of a tangential flow filtration configuration is that the filter cake (which can blind or foul the filter) is substantially washed away during the filtration process, increasing the length of time that a filter unit can be operational. Tangential flow filtration can be a continuous process, unlike batch-wise dead-end filtration. Tangential flow filtration is typically selected for feeds containing a high proportion of small particle size solids and where the permeate is the more valuable fraction because solid material can quickly block the filter surface with dead-end filtration.

As used herein, the expression “pounds per square inch,” or commonly psi, refers to a unit of pressure resulting from a force of one pound-force applied to an area of one square inch. As used herein, the expression “psia,” or “psi absolute,” or “absolute pressure” refers to a pressure reading that is relative to a vacuum rather than the ambient atmospheric pressure. Since atmospheric pressure at sea level is about 14.7 psi, this increment is added to any gauge pressure reading made in air at sea level to arrive at psi absolute. Conversely, “psig” or “psi gauge,” or “gauge pressure” is used to indicate that a given pressure reading is relative to atmospheric pressure, that is to say, represents the pressure that exceeds the atmospheric pressure at the altitude where the pressure was read.

While the foregoing disclosure has been described in some detail for purposes of clarity and understanding, it will be clear to one skilled in the art from a reading of this disclosure that various changes in form and detail can be made without departing from the true scope of the invention.

As used herein, the expression “pounds per square inch,” or commonly psi, refers to a unit of pressure resulting from a force of one pound-force applied to an area of one square inch. As used herein, the expression “psia,” or “psi absolute,” or “absolute pressure” refers to a pressure reading that is relative to a vacuum rather than the ambient atmospheric pressure. Since atmospheric pressure at sea level is about 14.7 psi, this increment is added to any gauge pressure reading made in air at sea level to arrive at psi absolute. Conversely, “psig” or “psi gauge,” or “gauge pressure” is used to indicate that a given pressure reading is relative to atmospheric pressure, that is to say, represents the pressure that exceeds the atmospheric pressure at the altitude where the pressure was read. As used herein, the term “pascal (Pa)” is a unit of pressure defined as one Newton per square meter. The term “megapascal (MPa)” refers to 1,000,000 pascal units. One MPa is equivalent to 145.0377 psi.

As used herein, the expression “thermal processing” or “thermal treatment” or “heat treatment” or equivalent expressions as applied to food or beverage processing refers generally to the application of heat (i.e., elevated temperatures, e.g., to any temperature above ambient temperature) to a food or drink product during processing and/or packaging, which can be for a variety of reasons. Thermal treatment can be a required step in the manufacture of the food or beverage product, for the purpose of enhancing the organoleptic properties of the food or drink material, for eliminating all microbial organisms from a product (i.e., sterilization, which can be absolute sterilization or commercial sterilization), for reducing the total microbial load (e.g., pasteurization), or for eliminating or reducing potentially pathogenic microorganisms. In some contexts, thermal processing is applied to food or beverage products to improve food or beverage safety or for extending the storage period, i.e., shelf life, of the treated food or beverage. Heat can be applied to food or beverage products to varying degrees and in a variety of different manners. Thermal treatment is historically used in both commercial sterilization protocols as well as pasteurization treatments. Heat can be applied to food products using different techniques and in the context of other treatment variables, including for example, dry heat, heat in the presence of steam or water, flash heat treatments versus longer intervals of treatment, and heat application in the presence of elevated pressures (e.g., retort treatments).

### II. Methods of the Invention

The invention provides methods for generating concentrated red wine products that find a variety of uses. Generally, these methods combine the processes of flash détente grape processing, traditional fermentation, and followed by tangential flow filtration (TFF) concentration. The methods of the invention incorporate the following steps:

(A) Harvesting

Grapes used for red wine production are cultured and harvested using methods consistent with established methods for cultivation and harvest as known in the industry. The grapes that are cultured and harvested can be generated from a single grape varietal or cultivar, or alternatively, can be a mixture of any plurality of grape varietals or cultivars. In some embodiments, the grapes are a single varietal or cultivar of Vitis vinifera, or a combination of varietals and or cultivars of Vitis vinifera.

In some embodiments, the harvested grapes can optionally be processed through a destemming apparatus prior to further treatment steps. In some embodiments, the process of destemming will break and rupture a high portion of the skins. In some embodiments, the harvested grapes are fed into the destemmer at a regular rate by a hopper.

The methods of the invention may or may not employ an explicit crushing step prior to flash détente processing. In methods of the invention where the grape material undergoes a destemming step, a crushing step is optional.

(B) Flash Détente Processing

The harvested grapes (e.g., destemmed and crushed grapes) are processed using a flash détente methodology known to provide a high degree of color extraction. Flash détente has two critical procedural components, which are (i) heating, and (ii) exposure to vacuum.

(i) Heating. The first step is to expose the harvested grapes to a heating step. This heating step can be to any suitable elevated temperature, for example, to an elevated temperature in the range of 170-195° F. In some embodiments, a higher temperature in the range of 190-210° F. can be used. In some embodiments, approximately 180° F. is an optimal temperature. This heating step creates steam from the water content in the grape must.

(ii) Vacuum exposure. The heated preparation as described in the step above is delivered to a vacuum chamber. The preparation is exposed to a vacuum, typically in the range of 7-10 inches of mercury (Hg), alternatively 0.8-1.0 bar, although the degree of vacuum that is applied can be any suitable vacuum outside this range. Heat removal is effected by the withdrawal of steam from the vacuum in the chamber. The steam vapor is then exposed to a chilling step that causes the steam to condense, and the resulting liquid is removed and discarded. The chilling step that results in the condensation and collection of the condensate can be at any suitable temperature, and is not limited by temperature in any aspect. In some embodiments, any temperature less than about as 110° F. is suitable. In other embodiments, temperatures less than about 100° F. are used. In still other embodiments, still cooler temperatures can be used, for example, temperatures less than about 90° F., less than about 80° F., less than about 75° F., less than about 70° F., less than about 65° F., or less than about 60° F.

Following exposure to the vacuum and removal of the condensate, the flash détente treated grape material can be pumped directly to the next processing step. Alternatively, the flash détente treated grape material can be temporarily held, typically in chilled or refrigerated conditions, for practical logistic considerations of collecting sufficient volumes of starting material until appropriate batch or vessel size has been achieved, and the material is chilled or refrigerated to retain quality of the product, curb spoilage, and/or prevent or slow oxidation or otherwise prevent the loss of quality of the flash détente treated material.

(C) Pressing

The liquid from the material subjected to the flash détente processing is collected after the vacuum exposure and prepared for fermentation. Collection and preparation of the flash détente treated grape must material can be made by various methods, the choice of which is non-limiting.

In some embodiments, the flash détente treated grape material is pumped and delivered to a press, where the material is suitably pressed using methods known in the art to generate a clear grape juice, which will be used for downstream fermentation.

In some embodiments, the flash détente treated grape material is delivered directly to fermentation tanks, where the material will be fermented in the presence of the whole grapes with grape skins, similarly using techniques known in the art.

In still other embodiments, a free run collection is made from the flash détente treated grape material. The free run fraction can be isolated and segregated for further processing, or it may optionally be pooled with a press fraction that is generated by a pressing of the flash détente treated grape material.

Following pressing of the flash détente treated product, the clear grape juice can be optionally chilled and held for practical logistic considerations, such as collecting sufficient volumes of starting material until appropriate batch or vessel size has been achieved. The pressed product is chilled to preserve quality of the product, consistent with industry protocols.

In some embodiments, the chilling is delayed or omitted in order to allow for optimal enzymatic treatment, for example, pectinase treatment. In some embodiments, the pressed fraction is chilled to between about 59 and 63° F., for example to about 60° F., prior to inoculation with yeast to initiate fermentation.

(D) Fermentation

The clear grape juice collected from the flash détente pressing or the whole grape must is subjected to fermentation consistent with industry practices using primary alcoholic fermentation (using yeast based fermentation) and secondary fermentation, i.e., malolactic fermentation (using a bacterial fermentation).

Fermentation is accomplished through inoculation with purified, commercially acceptable and known yeast strains for primary (alcoholic) fermentation and purified, commercially acceptable and known strains of bacteria (Oenococcus sp.) for secondary (malolactic) fermentation. In embodiments where whole grape must is initially fermented, the timing of the pressing of the must is performed at the winemakers discretion.

(E) Tangential Flow Filtration Concentration

The fermented juice is subjected to a filtration concentration process, namely a tangential flow filtration, where the retentate is captured and is used as concentrated wine product. The degree of concentration is optimized for the intended use of the product. For example, when used for wine blending, optimal concentrations of product can be expressed in volume:volume ratios of the concentrated product compared to the volume of fermented starting material. For example, the concentrated wine products can be in the range of 35-95% concentrated. This is to say, 35-95% of the volume of the fermented starting material is removed from the filtration stream, leaving behind a concentrated fraction that is 5-65% of the original starting volume prior to filtration.

In some embodiments, tangential flow ultrafiltration is used, but nanofiltration and reverse osmosis processes also find use with the invention. This methodology results in the concentration of subsets of wine solutes in the tangential flow filtration retentate, thereby concentrating preferred colored pigments and flavors of the wine in a smaller aqueous volume.

Prior to the start of the tangential flow filtration to concentrate the wine product, the starting material can be optionally pretreated by various treatment steps to aid and optimize the manufacture process. These steps, as well as other non-enumerated steps, that can optionally be employed are non-limiting, and are known in the industry. For example, in some embodiments of the invention, there are three distinct filtration operations performed after the fermentation and prior to the filtration concentration process. First, there is a rough filtration down to approximately 5 microns following completion of secondary fermentation. Second, there is a clarifying cross-flow microfiltration (0.2 microns) prior to the final concentration. Third, a sterile (0.45 micron absolute) in line filtration step ahead of the concentration step is employed to ensure that yeast and bacteria are excluded from the concentrated product.

(F) Color-Concentrated Wine Product Collection and Packaging

Following the concentration of the wine in the tangential flow filtration retentate, that concentrated fraction is collected, and in some embodiments is treated with SO₂ as well as sparged with inert gas to promote stability during storage. The variety and volumes of subsequent packaging is non-limiting, and can include standardized sizing and packing options as well as uniquely tailored custom orders. For example, in some embodiments, the packaging volumes can range from 750 mL bottles, to kegs of any size, to 300-gallon totes and tanker truck quantities.

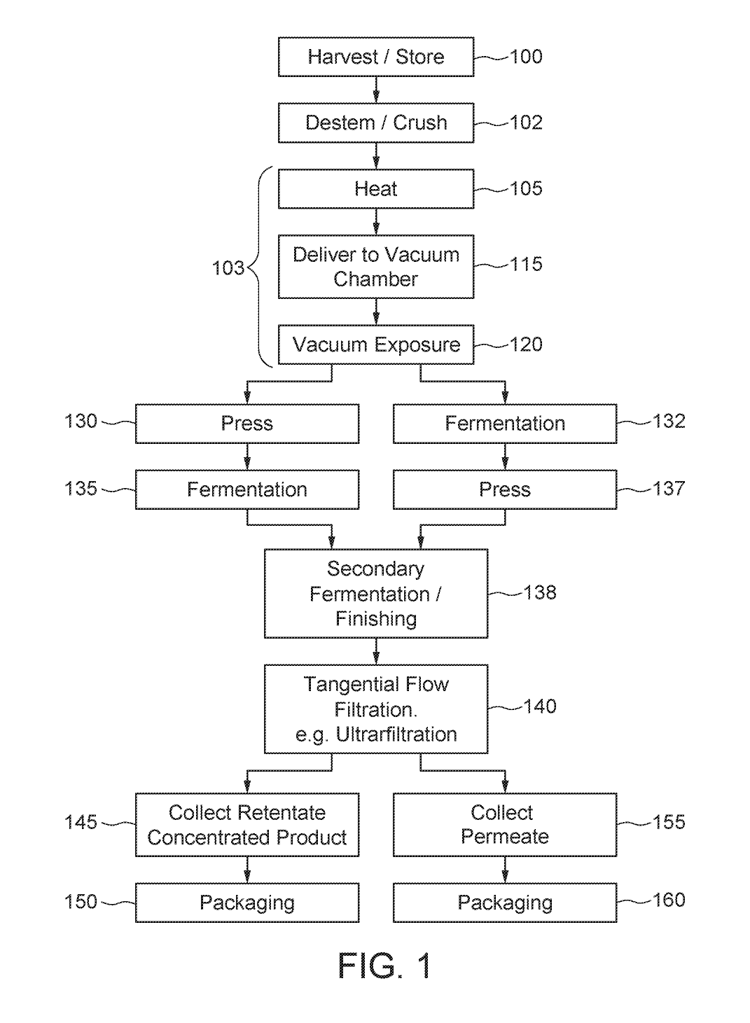

One embodiment of a method of the invention for the production of concentrated wine products follows the process flowchart depicted in FIG. 1. Grapes used for red wine production one or wine varietal or cultivar are harvested and stored 100. Those harvested grapes are optionally destemmed 102 prior to further processing. In some embodiments, destemming and crushing occur in the same apparatus in the same processing step, generating a grape must. The grape must is then subjected to flash détente processing 103, which includes heating 105 and delivery to a vacuum chamber 115, where the heated grape preparation is exposed to vacuum 120 to generate a steam/vapor, which is then condensed and discarded. The vacuum exposure 120 and collection of the condensate reduces the temperature of the grape must. Following exposure to the vacuum 120, the treated material can take either one of two alternatively routes. First, the treated grape must can be pressed 130, generating a clear grape juice. That clear grape juice is then sent to for fermentation 135 following traditional industry protocols. Where the clear grape juice is used in fermentation, that process is termed liquid phase fermentation. Alternatively, the treated grape generated by the flash détente treatment can be sent directly to fermentation vessels 132 without first pressing, which is termed solid phase fermentation. In that solid phase fermentation, the grape must is pressed 137 after the fermentation process 132 or at any time during the fermentation process 132 according to the wine maker's discretion.

The primary (i.e., alcoholic) fermentations 132 or 135 can be followed by secondary fermentation 138, as known in the industry, and is true for both the solid phase fermentation pathway 120-132-137-138 and for liquid phase fermentation pathway 120-130-135-138. The secondary fermentation step 138 can also be coupled any wine finishing steps, as known in the industry.

Following the primary fermentations in either solid phase fermentation 132 or liquid phase fermentation 135, and following the secondary fermentation 138, the fermented material is processed by tangential flow filtration, e.g., tangential flow ultrafiltration 140. That tangential flow filtration 140 produces a concentrated retentate product 145, and a permeate product 155. Both the retentate product and the permeate product are retained and collected for packaging 150 and 160.

Additional treatment steps can optionally be employed in the methods of the invention, for example, any discretionary wine finishing processes can be used. For example, a cross-flow filtration to prevent spoilage yeasts, remove sediment, promote microbial stability and improve wine aesthetics can be used prior to tangential flow filtration concentration.

III. Thermal Treatment and Flash Detente Processing

In red wine production, one of the most important process steps is the extraction of color compounds from grape skins. Classic maceration at “low” temperatures, e.g., 75-90° F., requires a long contact time and a bulky environment.

One way of accelerating color and polyphenol extraction is through thermovinification. In a traditional thermovinification process, crushed and de-stemmed grapes are pumped to a tubular heat exchanger where the must is heated for a few minutes at 176-185° F. This allows immediate inactivation of all endogenous enzymes (in particular oxidases like tyrosinase and laccase produced by microbial contaminants, e.g., by botrytis fungi.), and also results in a fast, efficient extraction of anthocyanins and tannins. The heated product is then piped to a cooling system where the temperature is lowered to 95-104° F. in the space of about 10-15 minutes.

Flash détente is the modern evolution of traditional thermovinification. In the flash détente process, crushed and de-stemmed grapes are rapidly heated, for example, in the range of about 170-195° F., or in the range of 175-185° F. The heated must is then immediately piped to a vacuum flash cooling chamber where the temperature is rapidly lowered to a temperature in the range of about 80-110° F., for example, to 86-90° F. Once in the vacuum chamber, some of the water associated with the must evaporates or “flashes” immediately into steam. This flash cooling depressurization causes vacuoles in the grapes skins to rupture, thus favoring the release of anthocyanins and skin tannins, better color extraction and avoiding the appearance of jammy characteristics which often appear in classically thermovinified wines, and minimizes bitter seed tannin and pyrazine (vegetal) odors. This release of the color and structure in many ways replaces the traditional maceration of punching down or pumping over. Wines produced by flash détente often have, on average, about 30% greater color and structure. In addition to the anthocyanin compounds, proanthocyanidin compounds (condensed tannins) are also present in the grape skin and will react with the anthocyanins to form polymeric pigments, further enhancing color and color stability.

Flash détente technology has typically been employed in winemaking for the removal of relatively low boiling point compounds that exhibit undesirable flavor/aroma attributes. However, the technology has the additional benefit of rendering a more intense color from red grape must in a manner superior to the thermovinification process.

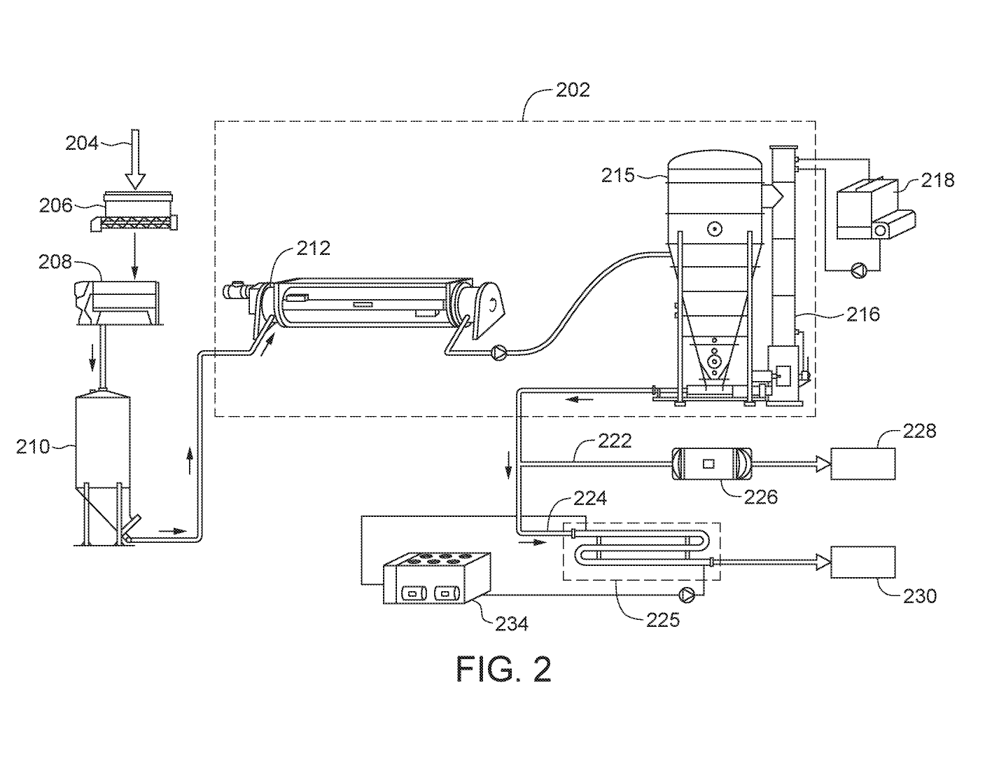

One embodiment of a flash détente protocol that finds use with the invention is depicted in FIG. 2. In this protocol, harvested red wine grapes 204 are placed into a hopper 206, and then fed through a destemmer 208, which can also be coupled with grape crushing. That processed material is held in a storage tank 210, that serves as a reservoir that feeds the flash détente processing phase 202. In this phase, grapes are fed from the storage tank 210 into a heating chamber 212, where the grape material is heated to a temperature of about 175-195° F. From the heating chamber 212, the heated material is sent to a vacuum chamber 215 where the grape must is exposed to vacuum. The vacuum creates a steam/vapor from the grape must. A cooling tower 216 and chilling apparatus 218 are coupled to the vacuum chamber 214, where the steam/vapor from the grape must condenses and is removed from the system. In the flash détente embodiment 202 shown in FIG. 2, the vacuum chamber 215 is coupled to a cooling tower 216 that resides external to the vacuum chamber. This configuration is not intended to be limiting, as vacuum chamber and condensation units can be constructed as a single integrated piece of equipment, where the cooling function resides inside the vacuum chamber.

Following flash détente treatment 202, the processed material can take one of two different pathways. First, the processed must material 220 from the vacuum chamber 215 can be delivered 222 to a grape press 226 to obtain a clear grape juice component from the must, which is then delivered to fermentation vessels 228 for liquid phase fermentation. Alternatively, the unpressed must from the vacuum chamber 215 can be sent directly 224 to fermentation vessels 230, where solid phase fermentation will proceed, at last for some portion of time, in the presence of the grape skins. During delivery of the grape must from the vacuum chamber 215 directly to the solid phase fermentation vessels 230, the grape must can be chilled by a heat exchange apparatus 225 coupled to a chiller unit 234 to reduce the temperature of the flow, for example, to approximately 59-63° F.

In one embodiment using this flash détente processing method as shown in FIG. 2, the red-wine processed grapes are pressed 226 to produce a clear juice for fermentation 228. In other embodiments also shown in FIG. 2, the pressing of the red wine grape must is delayed and fermentation 230 is initiated with grape must, and the pressing occurs after fermentation step or after a pre-determined time period, consistent with traditional red winemaking protocols.

### IV. Pressing and Free Run

The methods of the present invention can be modified in various aspects, and remain within the scope of the claimed invention. For example, the methods of the invention are not particularly limited with regard to the procedures used in pressing and fermenting the processed grape material.

For example, in some embodiments, the grape must can be pressed either before or after fermentation. That is to say, either liquid phase or solid phase fermentation techniques find use with the invention.

Furthermore, when grape must is pressed, the liquid fraction from the must can optionally be collected first in a free run collection of the grape must and followed by a press of the remaining grape materials to obtain the remaining liquid fraction. In some embodiments, the free run portion can be pooled with the pressed liquid portion for further processing. In some embodiments, only the free run portion is retained for further processing, producing a higher quality premium concentrated product. In some embodiments, the free run and press fraction are maintained as separate processing streams throughout the processing, resulting in the generation of two different products.

### V. Fermentation

Following collection of the liquid fraction(s) following the flash détente, the liquid is then processed for fermentation. The fermentation techniques used are consistent with industry protocols.

There are two choices for the fermentation step. First, the grapes can be pressed following the flash détente, and the resulting pressed juice is fermented, similar to traditional white wine production. Alternatively, the unpressed must following the flash détente treatment can be sent to a tank for traditional fermentation that includes the wine skins. In the second scenario, the must is pressed following the fermentation.

Consistent with routine practices in the industry, various adjuncts can be added to the extracted grape juice prior to alcoholic fermentation in order to facilitate fermentation, prevent oxidation/microbial spoilage and to promote and stabilize red color in the wine. These additives can include, for example but not limited to, yeast, supplemental nutrients, tartaric acid, SO₂, proanthocyanidins and nonflavonoid hydrolysable tannins (gallotannin and ellagitannin).

Once primary fermentation (i.e., alcoholic fermentation) has been completed, secondary fermentation (i.e., malolactic fermentation) will be initiated, again with the addition of proanthocyanidins and hydrolysable tannins. When fermentations are completed, the resulting wine will be racked, SO₂ adjusted, crossflow filtered for clarity and subjected to sterile filtration prior to tangential flow filtration concentration.

### VI. Tangential Flow Filtration (TFF) and Concentration

Following fermentation, the resulting fermented material is then concentrated by any suitable method as known in the industry. A variety of methods are known, all of which find use with the invention, without limitation. One of skill in the art is familiar with the various techniques available for concentrating wines, including tangential flow ultrafiltration (UF), tangential flow nanofiltration (NF) and tangential flow reverse osmosis (RO).

Tangential flow filtration, also termed crossflow filtration, is a type of filtration operation different from dead-end batch filtration. In batch filtration, the feed is passed through a membrane, filter or bed, the solids being trapped on or in the filter, and the filtrate is released on the opposite side of the filter. In tangential-flow filtration, the majority of the starting material feed flow travels tangentially across the surface of the filter, rather than into the filter, and the feed (and retentate flow) is maintained at a positive pressure relative to the permeate side of the filter membrane. In tangential flow filtration, a proportion of the material which is smaller than the membrane pore size passes through the membrane as permeate (or filtrate); everything else is retained on the feed side of the membrane as retentate.

The principal advantage of a tangential flow filtration configuration is that the filter cake (which can blind or foul the filter) is substantially washed away during the filtration process, increasing the length of time that a filter unit can be operational. Tangential flow filtration can be a continuous process, unlike batch-wise dead-end filtration.

Tangential flow ultrafiltration has been used for removal of undesirable compounds in wines, as those compounds of lower size/molecular weight that are in a greater concentration than desired. By utilizing tangential flow ultrafiltration for the purpose of low molecular weight compound removal, one can effectively concentrate the fraction left behind in the retentate by not adding back makeup materials to replenish that which is lost in the permeate.

The methods of the invention employ a continuously recycling tangential (also known as cross-flow) filtration configuration, also known as tangential flow filtration (TFF), to achieve concentration of the wine product. When using tangential flow filtration techniques, permeate and retentate fractions are produced which are the fractions that pass through the filter and retained by the filter, respectively. Suspended solids and solutes of high molecular weight are retained in the retentate, while water and low molecular weight solutes pass through the semi-permeable membrane in the permeate (also known as the filtrate). TFF removes one of the biggest obstacles of dead-end filtration, namely, the entrapment of insoluble particles leading to membrane clogging.

Product flow in TFF is tangential to the membrane surface, which has defined pore spaces and provides a smooth surface on which the liquid product (wine) can move rapidly. A combination of the insoluble particles and the wine's velocity continuously scrubs the surface. The main product flow space (the retentate) is subjected to pressure by the TFF system's pumps which drive the tangential flow. The pressure and speed keep the liquid and its particles moving, which allows the molecules that are smaller than the pores to pass through the membrane to the permeate side of the membrane. Tangential flow ultrafiltration, nanofiltration and reverse osmosis reflect differing stringencies (i.e., porosities) of the membranes used in the filtration.

The particular ultrafiltration, nanofiltration and reverse osmosis filtration membranes employed in the practice of the invention are known to one of skill in the art, and are not particularly limited in any aspect. A wide variety of semipermeable membrane materials, physical dimensions, porosities and tangential flow system configurations are known, all of which find use with the invention. Membrane porosity can be defined by the physical dimensions of the pores in the membrane (measured in microns) or by a molecular weight cut-off value (MWCO) in Daltons (Da).

Membranes can be of any standard composition such as for example but not limited to, a polysulfone, a fluoropolymer, cellulose acetate or the like. By varying the membrane pore size, pressures and the volumes of the permeate and retentate fractions, the vintner can regulate various organoleptic properties of the wine thus produced, for example, to produce wines with consistent and desirable organoleptic properties.

Advances in tangential flow filtration technology provide the vintner with the power to produce wines and concentrated wine products with tightly defined chemical characteristics and molecular selectivity, any of which can be utilized with the present invention. The filtration can be adapted to remove undesired particulate matter for clarification, but also is used beneficially for molecular segregation. Tangential flow filtration can remove volatile acids, and even remove the ethanol to a point where the wine product is alcohol-free. It is also possible to remove selected compounds based on molecular size, and in addition, fine tune molecular composition based on hydrophobicity versus hydrophilicity of various molecules. A filtration concentration system can also be used to select compounds based upon their chiral orientation.

The materials which constitute the membranes used in filtration systems may be either organic or inorganic. Organic membranes are made using a diverse range of polymers including cellulose acetate (CA), polysulfone (PS), polyvinylidenedifluoride (PVDF), polyethersulfone (PES), polyacrylonitrile (PAN), polyethylene (PE), polypropylene (PP), polytetrafluoroethylene (Teflon PTFE), polyamide-imide (PAI) and polyamide. These are most commonly used due to their flexibility and chemical properties. Polymeric membranes have a relatively low separation performance.

Inorganic microfiltration membranes are usually composed of sintered metal powders such as tungsten, palladium or stainless steel or porous alumina. Inorganic membranes such as ceramic membranes are made from materials such as silica, zeolite and various oxides such as aluminum oxide (Al₂O₃) and zirconium oxide (ZrO₂) and silicon dioxide (SiO₂). The inorganic membranes are able to be designed in various shapes, with a range of average pore sizes and permeability. In comparison with organic membranes, advantages that inorganic membrane possesses are high thermal and chemical stability, inertness to microbiological degradation, and ease of cleaning after fouling compared to organic counterparts.

Ultrafiltration

Generally, ultrafiltration (UF) is the tangential flow filtration of a liquid material using a filter having a porosity of between about 0.001 and 0.1 microns (μm). In some aspects, UF refers to a TFF process that uses filter porosity of about 0.01 microns. UF is distinguishable from microfiltration (MF), which uses more porous filtration membranes of about 0.1 micron (or larger) porosity. Dissolved salts and smaller molecules pass through the membrane. Items rejected by the membrane include colloids, proteins, microbiological contaminants and large organic molecules. Most UF membranes have molecular weight cut-off values between 1,000 and 100,000 Daltons (Da). UF typically uses filtration pressures of about 10-150 psig, or alternatively 15-100 psig (approximately 1-7 bar), where in contrast, microfiltration (MF) commonly uses pressures generally of about 5-15 psig. Any of a variety of semipermeable membrane materials can be used for ultrafiltration, as known in the art.

Ultrafiltration (UF) is used in the wine industry for various purposes. In some aspects, UF is used to separate the wine into two color fractions—low color and high color. The low color fraction can be used for blending purposes, while the high color fraction is the desired product. UF is also a useful tool for winemakers to increase the concentration of the wine, while still keeping the wine “balanced.” Other applications for UF include color removal, removal of bitter tannins and raising the concentration of color.

Filtration concentration, such as by UF, is most frequently used for color adjustments of red wines by concentrating the wine. In some applications, UF removes wine components which may be concentrated and utilized in other wines, resulting in very small overall process losses. Ultrafiltration of red wine can also provide two separate wines that each stand alone on their own merits. A partial concentration of color and tannin in a red wine can make it more robust and appealing; for example, a red wine can be concentrated by about 10-30%, most preferably not over 20%, for example, concentrated by about 8-15%, to produce a wine that is more robust and appealing. Conversely, the permeate that is produced from the ultrafiltration process may be utilized in as a rosé, blanc de noir or white zinfandel type of wine.

Nanofiltration

Nanofiltration (NF) refers to a membrane filtration process which rejects particles with approximate cut-off size of 0.001 microns (i.e., 1 nanometer, or 10 Angstroms). NF operation generally occur in a realm between and has some overlap with ultrafiltration and reverse osmosis porosity sizing. NF generally delivers slightly coarser filtration than RO. Nanofiltration impacts molecules generally in the molecular size range from 100 to 1,000 Daltons, and typically in the smaller range 200-400 Daltons, where organic molecules with molecular weights greater than that are rejected by the nanofilter. All organic acids, esters, terpenes and many small molecular weight phenolic compounds fall into this category. Also, some dissolved salts are rejected by nanofilters depending on the monovalent or divalent nature of the molecules and the particular nanofilter specifications that are utilized. Transmembrane pressures of typically 50 to 225 psig (3.5 to 16 bar), most typically over 200 psig, are used in nanofiltration processes.

Reverse Osmosis

Reverse osmosis (RO) is the finest level of filtration available. The RO membrane acts as a barrier to almost all dissolved salts and inorganic molecules, as well as organic molecules with a molecular weight greater than approximately 100 Daltons, although MWCO values can vary between 100-500 Daltons depending on the membrane filter design. Rejection of dissolved salts is typically 95 to greater than 99% efficiency. Water molecules, alcohol and small volatiles including acetic acid pass freely through a reverse osmosis membrane, thereby creating a relatively purified product stream in the permeate, and conversely, a retentate that has high molecular retention profile compared to the starting wine material. RO requires pressures greater than those used in nanofiltration, for example, in some applications RO uses pressures of approximately of 600 psig.

Concentration of the Wine Product

By varying the membrane pore size, pressures and the volumes of the permeate and retentate fractions in the tangential flow filtration step described above, the vintner can regulate various organoleptic properties of the wine thus produced, for example, to produce wines with consistent and desirable organoleptic properties. The degree of concentration of the wine product can vary based on intended use of the product. For example, in some embodiments, concentrations of flash-detente treated and fermented red wines of about 10-15% by volume are used in the methods of the invention. In other embodiments, concentrations of at least 20% by volume, or in excess of 20% by volume, are used in the methods of the invention. In other embodiments, concentrations of between about 20-30% by volume are used in the methods of the invention. In other embodiments, concentrations of about 50% by volume are used in the methods of the invention. In other embodiments, concentrations of about 20-90% by volume are used in the methods of the invention. In other embodiments, concentrations of about 30-90% by volume are used in the methods of the invention. In other embodiments, concentrations of about 30-50% by volume are used in the methods of the invention. In other embodiments, concentrations of about 50-90% by volume are used in the methods of the invention. Generally, higher degrees of volume concentration are preferred when producing a product that is to be used as a wine additive.

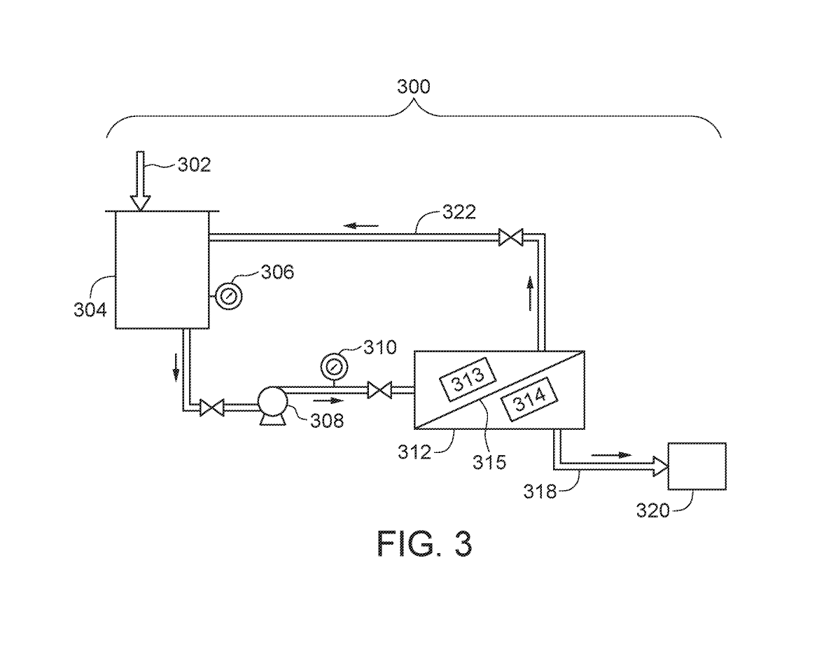

The schematic of FIG. 3 describes an ultrafiltration process whereby separation of two fractions of a complex liquid such as fermented wine (consisting of multiple constituents of varying molecular weight and other physical characteristics such as polarity and size) may be accomplished. Using this configuration, the objective is to continue filtration of the feedstock 302 from the process tank 304 until sufficient concentration of the continuously recycled retentate has been achieved to yield a product with acceptable color characteristics.

One embodiment of a tangential flow ultrafiltration system 300 finding use with the invention is shown in the schematic of FIG. 3. The schematic depicts the components of a tangential flow ultrafiltration system 300. Fermented wine material 302 is held in a process tank 304, which can be maintained at a suitable temperature, for example, a chilled temperature below ambient temperature, by temperature monitoring 306. The process material is delivered by a pump 308 to a tangential flow ultrafiltration module 312, where the material is pushed through the tangential flow ultrafiltration module 312 by a constant pressure or near constant pressure that is monitored by a suitable pressure sensor or gauge 310. Within the tangential flow ultrafiltration module 312, the wine is partitioned into either a retentate compartment 313 or a permeate compartment 314, based on whether or not various solutes in the wine are able to pass through the semi-permeable filter 315. The system is run as a continuous-flow recirculating system where the retentate reservoir 313 material is channeled by a retentate return line 322 back to the process tank 304. The permeate that passes through the semi-permeable filter 315 can be collected in a suitable vessel 320 for further processing. At any desired time, the concentrated retentate flow can be diverted and/or collected.

Processing of the finished wine using the ultrafiltration apparatus is continued until the concentrate (retentate) attains the necessary color parameters, typically as determined by the percentage volume reduction of the staring material during the course of continuous flow filtration, i.e., volumetric concentration. In some embodiments, the degree of color concentration can be monitored by measuring absorbance value during the course of the filtration. For example, monitoring Abs₄₂₀+Abs₅₂₀ is an effective metric to monitor the concentration of desired color pigments.

At the end of the filtration process, the retentate is discharged to a storage tank. The finished product is then chilled, sparged with inert gas and SO₂ or potassium metabisulfite (KMBS) adjusted for long term storage and eventual final packaging.

### VII. Chemical Characterization of Wines

Water pressed from the grape's pulp constitutes the single largest element of wine. The solute content of the resulting wines are complex mixtures of molecular species. The grape skins are responsible for the wine's aroma and flavor, as well as the color of the wine (from the anthocyanins) and the tannins. The complex mixture of solutes in wines result in the complex qualities of a wine, such as taste and mouthfeel. Wine solutes include ethanol, glycerol, organic acids, phenolics including tannins and anthocyanins, proteins, carbohydrates including various sugars, minerals and ions.

The phenolic compounds are major wine constituents that are responsible for a subset of wine's organoleptic properties including, in particular, color and astringency in wines produced from Vitis vinifera grapes. Phenolic compounds exhibit a wide diversity of structures, but they can be divided into flavonoids and non-flavonoids. The flavonoid compounds in wine are mostly extracted from the skins and seeds of grapes during fermentation. The non-flavonoids are represented by mostly phenolic acids (benzoic acids, hydroxycinnamic acids) and their esters and are present in the pulp of grapes at low levels. The various acids are differentiated by substitution of their benzene ring.

Flavonoids are characterized as molecules possessing two phenolic groups joined by a pyran (oxygen-containing) ring structure. The main flavonoid species important to the chemical reactions and sensory properties of red wine are the anthocyanins, catechins, flavanols, flavonols and tannins. Anthocyanin flavonoids are the principle source of pigmentation in red wine deriving from the grape skins and have no flavor or organoleptic taste property. Of the different anthocyanins found in grape, the most abundant is malvidin-3-glucoside. There are several forms of anthocyanins that exist in equilibrium at wine pH. Vitis vinifera red cultivars are rich in anthocyanins. The five most common anthocyanins found in the grape are:
cyanidin-3-O-glucoside
delphinidin-3-O-glucoside
malvidin-3-O-glucoside
petunidin-3-O-glucoside
peonidin-3-O-glucoside
In addition, some Vitis vinifera cultivars may also contain acetylated, coumaroylated and/or caffeoylated variants of these anthocyanins listed above.

A phenomenon known as copigmentation occurs in young red wines. Copigmentation is the enhancement of color due to formation of complexes between anthocyanins and colorless cofactors such as flavonols and hydroxycinnamates. Some cofactors can also cause the wine to take on a bluish appearance. As soon as the grapes are crushed, anthocyanins can react with many other must components (acetaldehyde, tannins, keto-acids, cinnamates) resulting in anthocyanin-derived pigments, initially described as polymeric pigments. Polymeric pigments are the source of “stable color” in red wine because they are more resistant to bisulfite bleaching and their color is not as pH dependent as anthocyanins.

Flavonoids also includes tannins, which contribute to the mouthfeel and aging of the wine. Tannin is the common name given to several classes of phenolic compounds. Tannins can be divided into two sub categories: condensed and hydrolyzable. Condensed tannins (proanthocyanidins) are the most abundant class of phenolics and are found in the grape, while the hydrolyzable tannins are the non-flavonoid ellagitannins derived from oak and found in wine. Tannins will combine with anthocyanins to form polymeric pigments, again a more stable source of color in red wine.

Flavonols are found in the epidermis of grape. The most recognized flavonol is quercetin-3-glucoside. Flavonols are also known as co-factors for the color-enhancing phenomenon known as copigmentation. They have yet to have been attributed a sensory component in wine.

The non-flavonoids found in V. vinifera grapes and resulting wines include the stilbenoids such as resveratrol and phenolic acids such as benzoic, caffeic and cinnamic acids.

### VIII. Permeate Collection and Uses

Permeate collected from the tangential flow filtration can be utilized for a variety of purposes, for example, as a rose wine, blending with lower quality wines that already have adequate color, as a sparkling wine base, for example, ameliorated and blended for secondary fermentation in Methode Champenoise and for use as distilling material.

### IX. Products of the Invention

In some embodiments, the invention includes the concentrated wine products that are generated by the methods of the invention. A variety of products are contemplated, for example, where the products of the invention have been concentrated to varying degrees.

In some aspects, by way of non-limiting examples, the invention includes concentrated wine products that are concentrated only 5-30% by volume (that is to say, the volume of the starting material is reduced by 5-30%, thereby leaving behinds a concentrated product that has 70-95% of the original volume of the starting material. These types of concentrated wine products can be used either as a drinkable finished wine, or as a wine product to be used as a component in the production of a blended wine.

In other aspects, by way of non-limiting examples, the invention includes concentrated wine products that are concentrated 30-80% by volume, where those concentrated products can be used as a component in the production of a blended wine.

In still other aspects, by way of non-limiting examples, the invention includes highly concentrated wine products that are concentrated, for example, 80-90% by volume, thereby leaving a concentrated wine product that has only 10-20% of the volume of the starting material, where those highly concentrated products can be used as an additive to enhance other wines, or as an additive or ingredient in preparing food products.

It is not intended that the invention be limited to the production of concentrated wine products have any given degree of concentration. A concentrated wine product manufactured by a method of the invention can have any degree of concentration. For example, a concentrated wine product of the invention can be a wine product whose starting material volume has been reduced by at least 10%, at least 20%, at least 30%, at least 40%, at least 50%, at least 60%, at least 70%, at least 80%, or at least 90%.

Products of the invention can be packaged in any suitable volume and type of containers. For example, when the concentrated wine product of the invention is to be used in making a blend wine, the product can be packaged in any size, for example but not limited to, in 5 gallon pails to 330 gallon totes. Smaller and larger packaged volumes are also contemplated and are within the scope of the invention.

### EXAMPLES

Aspects, features and advantages of the invention, as to its operation and use, will be understood and become more reality apparent when considered in view of the following detailed embodiments described in the following examples. The following examples are offered to illustrate, but not limit, the claimed invention. It is understood that various modifications of minor nature or substitutions with substantially similar reagents or components will be recognizable to persons of ordinary skill in the relevant art, and these modifications or substitutions are encompassed within the spirit and purview of this disclosure and within the scope of the invention.

### Example 1

### Generation of a Concentrated Wine Product

This example describes the manufacture of a concentrated wine product of the invention.

2017 Cabernet grapes from the San Joachim Valley were machine harvested. The grapes were crushed and destemmed. A feed of 1-1.5 tons per hour was conveyed into a flash détente apparatus of a like capacity. The grapes were heated to approximately 195° F., and fed directly into the flash détente vacuum chamber. Following the flash détente treatment, which included exposure to vacuum, the resulting must was pumped from the vacuum chamber directly into a 15-ton press. The temperature of the must upon exiting the chamber was approximately 203° F. At the end of a 10-12 hour shift, the flash détente apparatus was shut off. The press was then operated, and the resultant juice pumped into a tank for fermentation, Normal fermentation additives to include tartaric acid, ecological tannin, and nutrients were added, and the yeast introduced to the fermentation tank.

The process was continued until approximately 100 tons of Cabernet grapes had been crushed over a 2-week period. The resulting fermentations were consolidated at various stages until all the wine was dry. A portion of approximately 3,000 gallons was fermented with the skins and pressed following fermentation so that the results could be compared.

Once primary fermentation was complete, the resulting raw wines, approximately 12,000 gallons, were racked off the solids, tested for pH, and malolactic bacteria were introduced. Stabilizing tannins were added at that time. Once malolactic fermentation had been completed in the wines, samples were collected to determine heat and cold stability. The wines were stabilized, racked off lees and rough-filtered, then polish-filtered using a cross-flow micro-filter. The wine was then placed in a storage tank awaiting concentration.

The method of operation enables the creation of the final product on a need-specific basis. In this example, 375 gallons of wine were drawn off and filtered through a 0.45 micron sterile cartridge. A Winesecrets-constructed Targeted Filtration System equipped with a Suez Water Technologies and Solutions PW-4040 polyethersulfone ultrafiltration membranes, operated at 100-120 psi was employed to reduce the volume of the fermented grape product starting volume by approximately 83%. The Suez Water Technologies and Solutions PW-4040 membrane elements are characterized by a 20,000 molecular weight cut off (MWCO) and greater than 96% rejection of Cytochrome-C protein (13,300 MW protein).

The resulting retentate, which measured 63 gallons, was packaged for use as product samples. In this example, the retentate product was introduced directly into a bottling line and packaged in 375 ml wine bottles with cork stoppers.

A sample of this concentrated wine product was submitted for molecular compositions analysis.

### Example 2

### Protocol for Producing a Concentrated Wine Product

This example provides a detailed protocol for the production of a concentrated wine product of the invention. This protocol can be used to produce a concentrated wine product from any suitable grape(s), for example, Cabernet Sauvignon grapes. The steps of the procedure are outlined.
(A) FRUIT. Clean sound fruit with little MOG and preferably harvested and delivered cool.
(B) RECEIVING/CRUSHING/DE-STEMMING. Load fruit into to crusher/destemmer. Stems are discarded or used to add bulk during pressing. Must is fed into Flash Détente.
(C) FLASH DETENTE. Feed chamber temperature to be 180° F. and flow/capacity to comply with manufacturer specifications. Heat to 190-210° F. Discharge temp to be 90° F. Feed and discharge pumps are to be set and adjusted to maintain a level of product in the vacuum chamber that is half-way covering the sight glass. Maintain the vacuum at 0.8 to 1.0 bar.
(D) PRESS. Load flashed must into press. Add stems, pomace or rice hulls as needed to add bulk while pressing. Press. Combine free-run juice and pressings into fermentation tank.
(E) ADDITIONS: TANNIN AND PECTOLYTIC ENZYME.
   Add tannin (1st tannin add):
      Scottlabs “Uva-Tan” at a rate of 100-150 ppm, or
      Agrovin “Tanicol Vintage” at a rate of 100-150 ppm.
      Add tannin per manufacturer's instructions.
   Add pectolytic enzyme:
      Scottlabs “KS” at a rate of 5-8 ml/hL, or
      Agrovin “Enovin Pectinase” at a rate of 5-8 ml/hL,
      Add enzymes per manufacturer's instructions.
   Cool tank to 60° F.
(F) ANALYSIS. Analyze juice to determine pH adjustment, acid and nutrient needs. Target pH: 3.6-3.9. Target initial YANC of 150-200 ppm.
(G) pH ADJUSTMENT/ACID ADDITION. Use tartaric acid or cation exchange to lower pH to 3.6-3.9 to promote red/purple color retention and microbial stability.
(H) NUTRIENTS. Target 150-200 ppm YANC, not to exceed 8 lb/kgal. Use one-part DAP to two-parts Scottlabs “Fermaid K.” Nutrients added in 3 batches:
1. Add ½ A total nutrients at inoculation.
2. Add ¼ total nutrients at 18-17 brix.
3. Add ¼ total nutrients at 12-11 brix.
(I) INOCULATE: PRIMARY. Use 1.5 lb/kgal yeast. Use ScottLabs “NT112” or Agrovin “Character.” Add ½ total nutrients at inoculation. Target alcohol is 12.5%.
(J) PRIMARY FERMENTATION MANAGEMENT.
   18-17 brix: add ¼ total nutrients, additional 150-200 ppm tannin (2nd tannin add), additional acid if needed to keep pH in range. Gentile oxygenation can be performed at this step.
   12-11 brix: add ¼ total nutrients.
   Dry at <0.50 g/L G/F.
(K) INOCULATE: MALO-LACTIC. Once <0.5 g/L G/F, inoculate for malolactic fermentation. Use Scottlabs “VP 41” bacteria according to manufacturer's instructions. ML Dry at <0.10 g/L malate.
(L) ML DRY. Adjust to 50 ppm free SO₂. Chill to 60° F. and settle out solids. Rack off lees. Add tannin (3rd tannin addition): Scottlabs “Complex” at a rate of 100-150 ppm.
(M) STABILIZE. Run stability trials. Fine with gelatin: addition rate between 2.5-7.5 mL liquid gelatin per 100 liters of wine. Settle, then depth filter to remove colloids. Chill down to cold stabilize. Rack.
(N) FILTRATION. Crossflow (0.2 micron nominal). Sterile filter.
(O) CONCENTRATION. Ultrafiltration/concentration to 80%. Note: SO₂ will not pass through UF membrane. Check SO₂ in both permeate and concentrate before making additions.
(P) STORAGE AND TRANSPORT. Store and transport the concentrated wine product as you would store and transport any wine.

### Example 3

### Spectral Analyses

This example provides the results of spectral analyses that compares two samples. The first sample is a control sample wine that is a 2016 California Cabernet red wine. The second sample is a concentrated wine product produced according to the methods of the invention. The concentrated wine product, termed UX-520, was produced by concentrating a 2017 California Cabernet wine using flash detente processing and tangential flow ultrafiltration, as described herein.

Wine color intensity is quantitated by the sum of Abs420 and Abs520. As can be seen in the table below, the Abs420+Abs520 value for the concentrated wine product UX-520 has over six times greater color intensity as the non-concentrated control wine.

| | | Concentrated Wine |
|---|---|---|
| Spectral Data | Unconcentrated Wine | UX-520 |
| Abs 420 nm | 0.253 | 1.437 |
| Abs 520 nm | 0.314 | 2.088 |
| Color Intensity | 0.567 | 3.526 |
| Abs420 + Abs520 | | |
| Hue (Abs420/Abs520) | 0.804 | 0.688 |

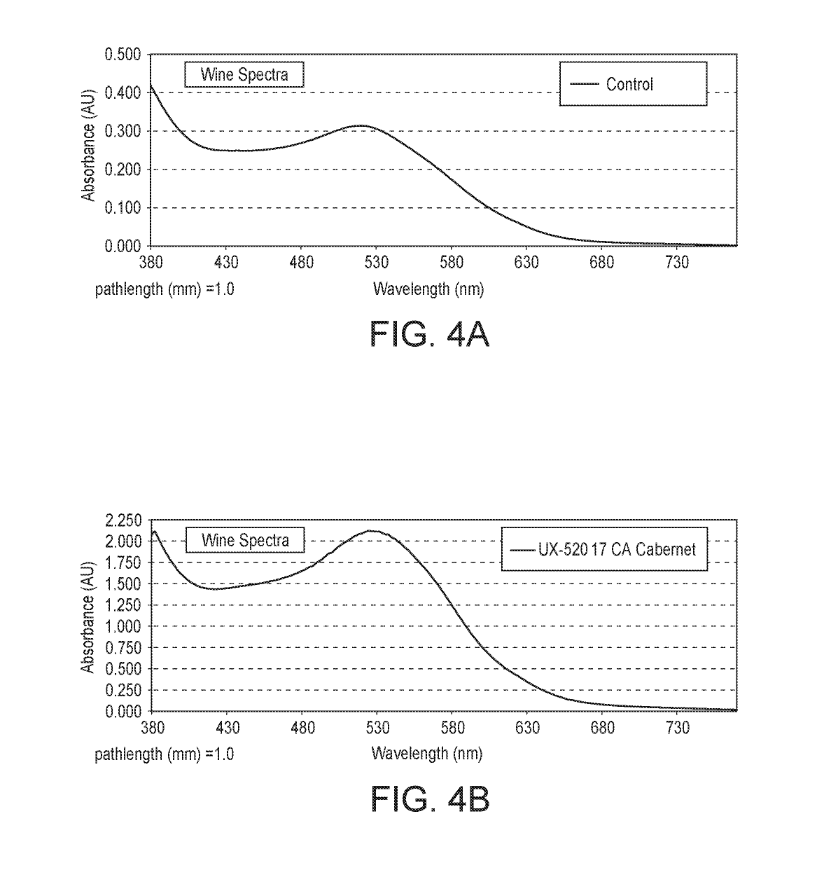

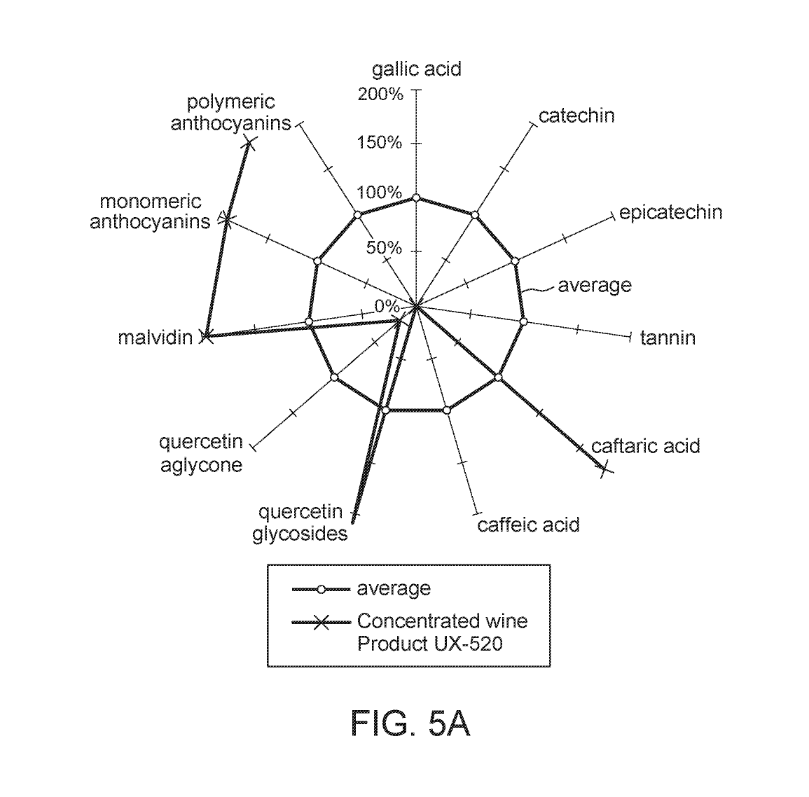

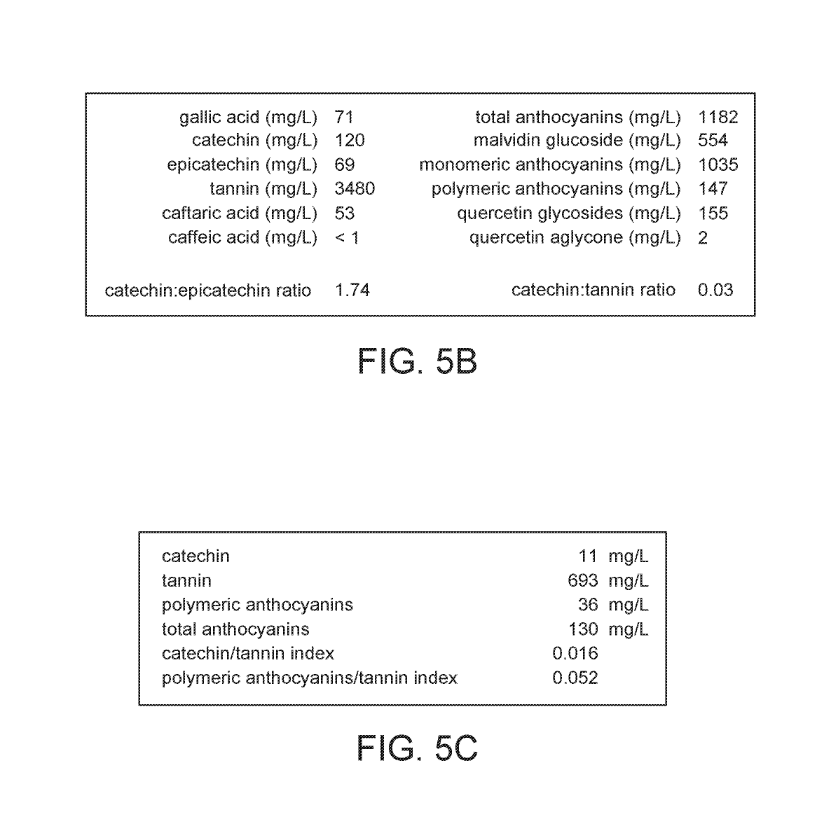

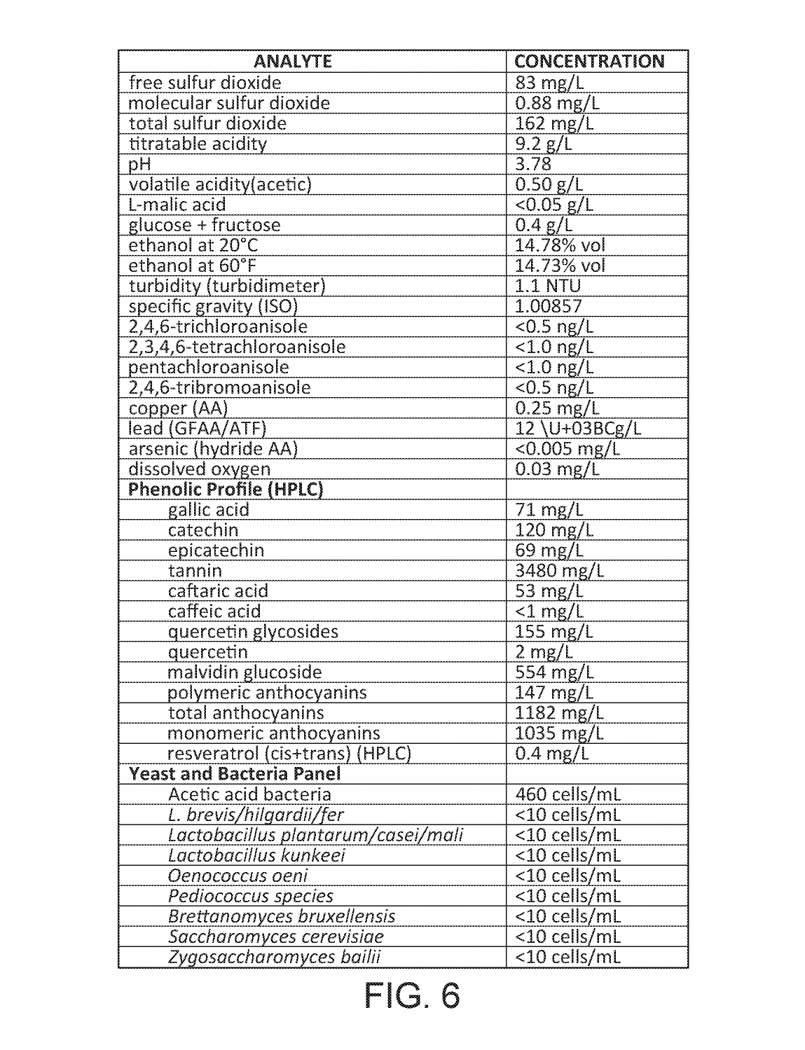

The full absorbance spectra of these same two samples is shown in FIGS. 4A and 4B. Note especially the different absorbance intensity Y-axes in these two plots.

### Example 4

### Efficacy Testing of Production Methodology

This example provides description of testing of the methods of the invention to assess the effectiveness of these methods in generating concentrated wine products, as measured by various criteria.

The methods of the invention rely on the use of both flash détente processing and tangential flow filtration in tandem to improve color and mouthfeel in a wine product, or generates a wine product that is enriched in components that make that concentrated wine a useful material in wine blending. It is theorized that a wine made using either one of these techniques alone (or neither) will not yield as intense a color and as rich a mouthfeel as wine made using the combination of the two.

In order to demonstrate this, four different trials are performed. These are:
1) Fermentation in the absence of both flash détente processing and tangential flow filtration (control);
2) Fermentation employing flash détente processing but in the absence of tangential flow filtration;

3) Fermentation in the absence of flash détente processing but employing tangential flow filtration;

4) Fermentation employing both flash détente processing and tangential flow filtration;

Analyses for both color and sensory attributes will be performed on the resulting products to validate the hypothesis, as well as quantify the degree to which color intensity and mouthfeel are improved over the control and single process wines, respectively.

### Example 5

### Organoleptic Analyses

This example provides description of organoleptic analyses to be conducted in the course of assessing the invention. These include visual color approximation (using Nessler tubes), tactile perception of astringency and taste perception of bitterness. Depending on the number of samples analyzed and replication, various types of statistical techniques can be employed (t test, binomial, one/two tail hypothesis).

A duo-trio methodology can be applied to this taste testing and visual inspections. Duo-trio implies a blind test insofar as the identity of the samples is unknown by the panelist evaluating the wines. Two are of one type and one of the other (usually experimental v control) for preference testing purposes. Usually replicates are performed where the samples are mixed relative to the two that are alike v one that is different for confidence of date purposes. Visual color is better perceived in a Nessler tube as it is volumetric and very long path length to intensify differences as viewed through back lighting. Tactile is simply the perception of astringency (polyphenolics) on the human palate and bitterness (monomeric tannins).

While the foregoing disclosure has been described in some detail for purposes of clarity and understanding, it will be clear to one skilled in the art from a reading of this disclosure that various changes in form and detail can be made without departing from the true scope of the invention. It is to be understood that the invention is not limited to any of the specifically recited methodologies, reagents, biological materials or instrumentation that are recited herein, where similar or equivalent methodologies, reagents, biological materials or instrumentation can be substituted and used in the construction and practice of the invention, and remain within the scope of the invention. It is understood that the description and terminology used in the present disclosure is for the purpose of describing particular embodiments of the invention only, and is not intended that the invention be limited solely to the embodiments described herein.

As used in this specification and the appended claims, singular forms such as “a”, “an” and “the” include plural referents unless the content clearly dictates otherwise. All industry and technical terms used herein have the same meaning as commonly understood by one of ordinary skill in the art or industry to which the invention pertains, unless defined otherwise.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A method for generating a concentrated wine product, the method comprising:
(a) generating a grape material from a Vitis vinifera grape varietal or cultivar;
(b) heating the grape material to a temperature in the range of 170-195° F.;
(c) exposing the grape material to vacuum conditions;
(d) fermenting the grape material, thereby generating a crude wine product;
(e) processing the crude wine product by a continuously recycling tangential flow filtration; and
(f) collecting a concentrated retentate fraction produced by the continuously recycling tangential flow filtration, thereby generating a concentrated wine product.

2. The method of claim 1, where generating a grape material from a Vitis vinifera grape varietal or cultivar comprises generating a grape must.

3. The method of claim 1, further comprising between step (c) and (d) the step of pressing the grape material to generate a clear grape juice.

4. The method of claim 1, further comprising between step (d) and (e) the step of pressing the grape material to generate a clear grape juice.

5. The method of claim 1, wherein heating the grape material is to a temperature of about 180° F.

6. The method of claim 1, wherein exposing the grape material to vacuum conditions comprises vacuum conditions in the range of about 7-10 inches of mercury (Hg).

7. The method of claim 1, wherein fermenting the grape material comprises both a primary fermentation and a secondary fermentation.

8. The method of claim 1, wherein the tangential flow filtration is a tangential flow ultrafiltration.

9. The method of claim 1, wherein the tangential flow filtration comprises a filter having a porosity of between about 0.001 and 0.1 microns (μm).

10. The method of claim 1, the method further comprising the step of clarifying the crude wine product immediately prior to step (e).

11. The method of claim 1, wherein the concentrated retentate fraction produced by the continuously recycling tangential flow filtration has a volume that is not more than about 10% of the volume of the crude wine product.

12. The method of claim 1, wherein the concentrated retentate fraction produced by the continuously recycling tangential flow filtration has a volume that is not more than about 20% of the volume of the crude wine product.

13. The method of claim 1, wherein the concentrated retentate fraction produced by the continuously recycling tangential flow filtration has a volume that is not more than about 30% of the volume of the crude wine product.

14. The method of claim 1, wherein the concentrated retentate fraction produced by the continuously recycling tangential flow filtration has a volume that is not more than about 50% of the volume of the crude wine product.

15. The method of claim 1, wherein the concentrated retentate fraction produced by the continuously recycling tangential flow filtration has a volume that is not more than about 80% of the volume of the crude wine product.

16. A concentrated wine product produced by the method of claim 1.

17. A concentrated wine product, wherein the concentrated wine product is characterized by:
(a) a color density of greater than 3.526, wherein the color density is the sum of Abs₄₂₀ and Abs₅₂₀;
(b) a concentration of monomeric anthocyanins of at least about 1035 mg/L;
(c) a concentration of polymeric anthocyanins of at least about 147 mg/L; and
(d) a concentration of malvidin glucoside of at least about 554 mg/L.

18. A method for producing a blended wine product, the method comprising:
(a) providing at least one base wine,
(b) providing a concentrated wine additive, where the concentrated wine additive is characterized by:
(i) a color density of greater than 3.526, wherein the color density is the sum of Abs₄₂₀ and Abs₅₂₀; and
(ii) a concentration of total anthocyanins of at least about 1182 mg/L;
(c) combining volumes of the at least one base wine and the concentrated wine additive where the volume of the concentrated wine additive is at least 2% of the volume of the at least one base wine; and where the at least one base wine and the concentrated wine additive are combined in a suitable proportion to produce a blended wine product having organoleptically desirable properties.

19. The method of claim 18, wherein the at least one base wine is an admixture of at least two base wines.

20. The method of claim 18, wherein the volume of the concentrated wine additive is at least 5% of the volume of the at least one base wine.
